(19) United States
(12) Patent Application Publication
(10) Pub. No.: US 2025/0243112 A1
(43) Pub. Date: Jul. 31, 2025

(54) METHOD FOR INCREASING AMOUNT OF AIR-QUENCHED STEEL SLAG AGGREGATE IN CONCRETE

(71) Applicants: CHINA RAILWAY NO.4 ENGINEERING GROUP CO., LTD, Anhui (CN); ANHUI ENGINEERING MATERIAL TECHNOLOGY CO, LTD OF CTCE GROUP, Anhui (CN); NATIONAL ENGINEERING RESEARCH CENTER OF HIGH-SPEED RAILWAY CONSTRUCTION TECHNOLOGY, Hunan (CN); YUNNAN CHINA RAILWAY NEW MATERIALS TECHNOLOGY CO., LTD, Yunnan (CN)

(72) Inventors: Dongdong FAN, Anhui (CN); Xinming JU, Anhui (CN); Jin CHEN, Anhui (CN); Xianzhu HU, Anhui (CN); Chunhong LIN, Anhui (CN); Yitao CHEN, Anhui (CN); Ajuan JIANG, Anhui (CN)

(73) Assignees: CHINA RAILWAY NO.4 ENGINEERING GROUP CO., LTD, Anhui (CN); ANHUI ENGINEERING MATERIAL TECHNOLOGY CO, LTD OF CTCE GROUP, Anhui (CN); NATIONAL ENGINEERING RESEARCH CENTER OF HIGH-SPEED RAILWAY CONSTRUCTION TECHNOLOGY, Hunan (CN); YUNNAN CHINA RAILWAY NEW MATERIALS TECHNOLOGY CO., LTD, Yunnan (CN)

(21) Appl. No.: 19/017,785

(22) Filed: Jan. 13, 2025

Related U.S. Application Data
(63) Continuation of application No. PCT/CN2024/089387, filed on Apr. 23, 2024.

(30) Foreign Application Priority Data
Jan. 25, 2024 (CN) 202410101903.2

(51) Int. Cl. C04B 18/14; C04B 20/02; C04B 40/00; C04B 40/02

(52) U.S. Cl. CPC C04B 18/142; C04B 20/023; C04B 40/0032; C04B 40/024

(57) ABSTRACT

Disclosed is a method for increasing an amount of air-quenched steel slag aggregate in concrete. The method includes the following steps: (1) weighing calcium lignosulfonate and silicon-containing powder, mixing same evenly to obtain a modifier, adding water to the modifier, and stirring same to dissolve, to obtain a modified slurry; (2) weighing air-quenched steel slag, pouring the modified slurry into the air-quenched steel slag, stirring same evenly, and placing same for drying to obtain modified air-quenched steel slag; and (3) mixing the modified air-quenched steel slag with stones, gravel, yellow sand and cement, adding water thereto, and stirring same evenly to obtain a mixture, molding the mixture to obtain a green body, and curing the green body.

### CROSS REFERENCE TO RELATED APPLICATIONS

The present application is a continuation application of international PCT application serial no. PCT/CN2024/089387, filed on Apr. 23, 2024, which claims the priority of the Chinese patent with the Application No. 202410101903.2, filed with China National Intellectual Property Administration on Jan. 25, 2024, and entitled “Method for increasing amount of air-quenched steel slag aggregate in concrete”, which is incorporated in its entirety herein by reference.

### TECHNICAL FIELD

The present disclosure relates to the technical field of steel slag waste recycling, and in particular to a method for increasing an amount of air-quenched steel slag aggregate in concrete.

### BACKGROUND

Air-quenched steel slag is obtained by first using high-speed airflow to break liquid steel slag falling from the air into tiny droplets and then cooling the tiny droplets in a water pool. A process of fine granulation not only makes air-quenched steel slag spherical, but also overcomes the difficulty of dissolving large pieces of lime in the slag. Free CaO content of air-quenched steel slag is extremely low, basically below 1%. Therefore, the air-quenched steel slag can be used as concrete aggregate.

However, a spherical surface of the air-quenched steel slag is relatively smooth, such that when the air-quenched steel slag is used as aggregate, occlusion with other aggregates is poor, and bonding with cement is also poor. In actual applications of using air-quenched steel slag as aggregate, it has been found that when content of air-quenched steel slag in concrete exceeds 45%, a resultant green body is brittle, has an extremely low strength, and is almost hardly molded, thereby significantly limiting use of the air-quenched steel slag in concrete.

### SUMMARY

### (I) Technical Problems to be Solved

In view of the defects in the prior art, the present disclosure provides a method for increasing an amount of air-quenched steel slag aggregate in concrete, and solves the technical problem of poor occlusion between air-quenched steel slag and aggregate.

### (II) Technical Solution

In order to achieve the above objective, the present disclosure is achieved by the following technical solution:

A method for increasing an amount of air-quenched steel slag aggregate in concrete, including the following steps:
(1) weighing calcium lignosulfonate and silicon-containing powder, mixing same evenly to obtain a modifier, adding water to the modifier, and stirring same to dissolve, to obtain a modified slurry;
(2) weighing air-quenched steel slag, pouring the modified slurry into the air-quenched steel slag, stirring same evenly, and placing same for drying to obtain modified air-quenched steel slag; and
(3) mixing the modified air-quenched steel slag with stones, gravel, yellow sand and cement, adding water thereto, and stirring same evenly to obtain a mixture, molding the mixture to obtain a green body, and curing the green body.

Preferably, in the step (1), a mass ratio of calcium lignosulfonate to silicon-containing powder is (1.5-2.5):(1-3).

Preferably, the silicon-containing powder is selected from at least one of fly ash or silica fume.

Preferably, the silicon-containing powder is a mixture of silica fume and fly ash.

Preferably, a mass ratio of the calcium lignosulfonate to the silica fume and to the fly ash is 2:1:1.

Preferably, a particle size of the air-quenched steel slag is 0.1-2.5 mm.

Preferably, the modifier accounts for 1-2% of a mass of the air-quenched steel slag.

Preferably, a mass ratio of the stones to the gravel, to the modified air-quenched steel slag, to the yellow sand and to the cement is 6:(0-25):(0-25):12:7.

Preferably, in the step (3), a water-cement ratio is 0.35-0.45.

Preferably, in the step (3), a molding pressure is 20-25 MPa, and curing parameters include: static curing time of 3-6 h, a steam curing temperature of 50-80° C., and steam curing time of 6-10 h.

### (III) Beneficial Effects

The present disclosure provides a method for increasing an amount of air-quenched steel slag aggregate in concrete. Compared to the prior art, the present disclosure has the following beneficial effects:

In the present disclosure, a modified slurry prepared from calcium lignosulfonate, silica fume and/or fly ash is used to modify a surface of air-quenched steel slag, where the calcium lignosulfonate has adhesiveness after being dissolved in water, such that silica fume and/or fly ash in the slurry are bonded to a spherical surface of the air-quenched steel slag, and a surface of the air-quenched steel slag is uneven after drying, thereby increasing the occlusion with other aggregates; and moreover, silica fume and fly ash can also react with Ca(OH)₂ generated by cement hydration to generate a hydraulic cementitious material, thereby improving a strength of concrete, and achieving effects of not only increasing an amount of modified air-quenched steel slag aggregate in concrete but also improving the strength of concrete.

### DETAILED DESCRIPTIONS OF THE EMBODIMENTS

In order to make the objectives, technical solutions and advantages of the examples of the present disclosure clearer, the technical solutions in the examples of the present disclosure will be clearly and completely described. Apparently, the examples described are merely some rather than all of the examples of the present disclosure. Based on the examples of the present disclosure, all other examples acquired by those of ordinary skill in the art without making creative efforts fall within the scope of protection of the present disclosure.

In an example of the present disclosure, there is provided a method for increasing an amount of air-quenched steel slag aggregate in concrete, which solves the technical problem of poor occlusion between air-quenched steel slag and aggregate, increases an amount of modified air-quenched steel slag aggregate in concrete, and improves a strength of concrete.

In order to solve the above problem, the general idea of the technical solution in an example of the present disclosure is as follows:

Particles of air-quenched steel slag are spherical and have a relatively smooth surface, thereby having relatively poor occlusion with other aggregates and poor bonding with cement. When content of air-quenched steel slag replacing part of gravel reaches 45%, a green body of product exhibits an extremely low strength and brittleness after demolding.

In order to solve the above technical problems, the present disclosure provides a method for increasing an amount of air-quenched steel slag aggregate in concrete, and the method includes the following steps:
(1) weigh calcium lignosulfonate and silicon-containing powder, mix same evenly to obtain a modifier, add water to the modifier, and stir same to dissolve, to obtain a modified slurry;
(2) weigh air-quenched steel slag, pour the modified slurry into the air-quenched steel slag, stir same evenly, and place same for drying to obtain modified air-quenched steel slag; and
(3) mix the modified air-quenched steel slag with stones, gravel, yellow sand and cement, add water thereto, and stir evenly to obtain a mixture, mold the mixture to obtain a green body, and cure the green body.

In the step (1), a mass ratio of calcium lignosulfonate to silicon-containing powder is (1.5-2.5):(1-3).

The silicon-containing powder is selected from at least one of fly ash or silica fume. The calcium lignosulfonate has adhesiveness after being dissolved in water, such that silica fume and/or fly ash in the slurry are bonded to a spherical surface of the air-quenched steel slag, and a surface of the air-quenched steel slag is uneven after drying, thereby increasing the occlusion with other aggregates; and moreover, silica fume and fly ash can also react with Ca(OH)₂ generated by cement hydration to generate a hydraulic cementitious material, thereby improving a strength of concrete, and achieving effects of not only increasing an amount of modified air-quenched steel slag aggregate in concrete but also improving the strength of concrete.

The silicon-containing powder is a mixture of silica fume and fly ash.

A mass ratio of the calcium lignosulfonate to the silica fume and to the fly ash is 2:1:1.

A particle size of the air-quenched steel slag is 0.1-2.5 mm.

The modifier accounts for 1-2% of a mass of the air-quenched steel slag. The modifier accounts for 1.5% of a mass of the air-quenched steel slag.

A mass ratio of the stones to the gravel, to the modified air-quenched steel slag, to the yellow sand and to the cement is 6:(0-25):(0-25):12:7. In the step (3), a water-cement ratio is 0.35-0.45. For example, when the modified air-quenched steel slag replaces all the gravel, a mass ratio of the stones to the modified air-quenched steel slag, to the yellow sand and to the cement is 6:25:12:7, and a water-cement ratio is 0.4.

In the step (3), the mixture is poured into a pressing mold for pressurized molding, the green body is statically cured for a period of time, then steam-cured for a period of time, and is finally standard-cured in a curing box for 28 d. The molding pressure is 20-25 MPa, curing time is 3-6 h, a steam curing temperature is 50-80° C., and steam curing time is 6-10 h. For example, the molding pressure is 22 MPa, the curing time is 4 h, the steam curing temperature is 60° C., and the steam curing time is 8 h.

In order to better understand the above technical solution, the above technical solution will be described in detail below with reference to specific embodiments.

### Example 1

In this example, a method for increasing an amount of air-quenched steel slag aggregate in concrete is provided, including the following steps:
(1) Weigh 100 g of calcium lignosulfonate, 50 g of fly ash, and 50 g of silica fume, mix same evenly, add water thereto, and stir same to dissolve, to obtain a modified slurry.
(2) Weigh 20 kg of air-quenched steel slag with a particle size of 0.1-2.5 mm, pour the modified slurry into the slag, stir same evenly, and place same for drying to obtain modified air-quenched steel slag.
(3) Mix the modified air-quenched steel slag with 6 kg of stones, 5 kg of gravel, 12 kg of yellow sand and 7 kg of cement, add 2.8 kg of water thereto, and stir same evenly to obtain a mixture. Pour the obtained mixture into a pressing mold in batches with 4 kg each time, after molding at a pressure of 22 MPa, perform static curing of a green body for 4 h, then perform steam curing at 60° C. for 8 h, and finally perform standard curing in a curing box for 28 d.

### Example 2

Weigh 112.5 g of calcium lignosulfonate, 56.25 g of fly ash, and 56.25 g of silica fume, mix same evenly, add water thereto, and stir same to dissolve, to obtain a modified slurry.

Weigh 22.5 kg of air-quenched steel slag with a particle size of 0.1-2.5 mm, pour the modified slurry into the slag, stir same evenly, and place same for drying to obtain modified air-quenched steel slag.

Mix the modified air-quenched steel slag with 6 kg of stones, 2.5 kg of gravel, 12 kg of yellow sand and 7 kg of cement, add 2.8 kg of water thereto, and stir same evenly to obtain a mixture. Pour the obtained mixture into a pressing mold in batches with 4 kg each time, after molding at a pressure of 22 MPa, perform static curing of a green body for 4 h, then perform steam curing at 60° C. for 8 h, and finally perform standard curing in a curing box for 28 d. (1%, 45%)

### Example 3

Weigh 125 g of calcium lignosulfonate, 62.5 g of fly ash, and 62.5 g of silica fume, mix same evenly, add water thereto, and stir same to dissolve, to obtain a modified slurry.

Weigh 25 kg of air-quenched steel slag with a particle size of 0.1-2.5 mm, pour the modified slurry into the slag, stir same evenly, and place same for drying to obtain modified air-quenched steel slag.

Mix the modified air-quenched steel slag with 6 kg of stones, 12 kg of yellow sand and 7 kg of cement, add 2.8 kg of water thereto, and stir same evenly to obtain a mixture. Pour the obtained mixture into a pressing mold in batches with 4 kg each time, after molding at a pressure of 22 MPa, perform static curing of a green body for 4 h, then perform steam curing at 60° C. for 8 h, and finally perform standard curing in a curing box for 28 d. (1%, 50%)

### Example 4

The difference between this example and Example 2 lies in that proportions of calcium lignosulfonate, fly ash and silica fume are different, as detailed in Table 1, and all other aspects are the same as Example 2.

### Example 5

The difference between this example and Example 2 lies in that proportions of calcium lignosulfonate, fly ash and silica fume are different, as detailed in Table 1, and all other aspects are the same as Example 2.

### Example 6

The difference between this example and Example 3 lies in that amounts of modifiers added thereto are different, as detailed in Table 1, and all other aspects are the same as Example 3.

### Example 7

The difference between this example and Example 3 lies in that amounts of modifiers added are different, as detailed in Table 1, and all other aspects are the same as Example 3.

### Example 8

The difference between this example and Example 3 lies in that modifier components include calcium lignosulfonate and fly ash, but do not include silica fume, and all other aspects are the same as Example 3.

### Example 9

The difference between this example and Example 3 lies in that modifier components include calcium lignosulfonate and silica fume, but do not include fly ash, and all other aspects are the same as Example 3.

### Comparative Example 1

The difference between this comparative example and Example 1 lies in that air-quenched steel slag aggregate is not modified, and all other aspects are the same as Example 1.

### Comparative Example 2

The difference between this comparative example and Example 2 lies in that air-quenched steel slag aggregate is not modified, and all other aspects are the same as Example 2.

### Comparative Example 3

The difference between this comparative example and Example 2 lies in that proportions of calcium lignosulfonate, fly ash and silica fume are different, and all other aspects are the same as Example 2.

### Comparative Example 4

The difference between this comparative example and Example 3 lies in that modifier components do not include calcium lignosulfonate, and all other aspects are the same as Example 3.

### Comparative Example 5

The difference between this comparative example and Example 3 lies in that modifier components do not include fly ash and silica fume, and all other aspects are the same as Example 3.

TABLE 1
Component formulations and properties test results
of Examples 1-9 and Comparative Examples 1-5

| | Calcium lignosulfonate/fly | | Air-quenched | Compressive |
|---|---|---|---|---|
| | ash/silica fume | Modifier | steel slag | strength |
| | (g/g/g) | content | content | (MPa) |
| Example 1 | 2:1:1 | 1% | 40% | 40.05 |
| Example 2 | 2:1:1 | 1% | 45% | 41.96 |
| Example 3 | 2:1:1 | 1% | 50% | 43.27 |
| Example 4 | 1.5:0.5:0.5 | 1% | 45% | 41.13 |
| Example 5 | 2.5:1.5:1.5 | 1% | 45% | 40.87 |
| Example 6 | 2:1:1 | 0.5% | 50% | 41.35 |
| Example 7 | 2:1:1 | 1.5% | 50% | 42.14 |
| Example 8 | 2:2:0 | 1% | 50% | 42.06 |
| Example 9 | 2:0:2 | 1% | 50% | 41.82 |
| Comparative | — | — | 40% | 38.92 |
| Example 1 | | | | |
| Comparative | — | — | 45% | Green body |
| Example 2 | | | | broken after |
| | | | | demolding |
| Comparative | 1:1:1 | 1% | 45% | Green body |
| Example 3 | | | | brittle after |
| | | | | demolding |
| Comparative | 0:1:1 | 1% | 50% | Green body |
| Example 4 | | | | broken after |
| | | | | demolding |
| Comparative | 2:0:0 | 1% | 50% | Green body |
| Example 5 | | | | fragile after |
| | | | | demolding |

It can be seen from Table 1 that unmodified air-quenched steel slag aggregate is used to prepare concrete samples in Comparative Examples 1 and 2, a compressive strength of the samples is 38.92 MPa when content thereof is 40%, and when the content is 45%, green bodies of the samples are broken after demolding, and the compressive strength decreases sharply, indicating that the content of 45% is an upper limit for preparing concrete samples with the unmodified air-quenched steel slag aggregate. In Example 3, a concrete sample is prepared with modified air-quenched steel slag aggregate with content of 50%, and a compressive strength of the sample is 43.27 MPa, indicating that the modified air-quenched steel slag not only increases an amount of air-quenched steel slag aggregate in concrete, but also improves a strength of concrete.

In Comparative Example 3, components of the modifier include calcium lignosulfonate and silicon-containing powder with a mass ratio of 1:2, and a green body of a prepared concrete sample is brittle after demolding. Mass ratios of calcium lignosulfonate to silicon-containing powder in the modifiers of Examples 2, 4 and 5 are 2:2, 1.5:1 and 2.5:3, respectively, and compressive strengths of the prepared concrete samples are 41.96 MPa, 41.13 MPa and 40.87 MPa, respectively, indicating that the mass ratio of the modifier component calcium lignosulfonate to the silicon-containing powder affects properties of the modified air-quenched steel slag. When the mass ratio of calcium lignosulfonate to silicon-containing powder is (1.5-2.5):(1-3), a modifier formed is used to modify air-quenched steel slag, content of modified air-quenched steel slag aggregate in concrete is large, and a compressive strength of a prepared concrete sample is high.

In Examples 3, 6 and 7, different amounts of a modifier are added, indicating that a compressive strength of a concrete sample first increases and then decreases with an increase in content of the modifier. When a mass ratio of the modifier to the air-quenched steel slag is 1%, a highest compressive strength is 43.27 MPa.

In Comparative Example 4, the modifier does not include calcium lignosulfonate, in Comparative Example 5, the modifier does not include silicon-containing powder, modified air-quenched steel slag aggregate is used to prepare concrete samples, and green bodies of the samples are all broken after demolding, and a compressive strength of Example 3 reaches 43.27 MPa, indicating that silicon-containing powder and calcium lignosulfonate have a synergistic effect in improving the compressive strength of concrete.

It is to be explained that the relation terms, for example, first, second, etc., are used herein merely for distinguishing one entity or operation from another entity or operation but do not necessarily require or imply that there exists any actual relation or sequence between these entities or operations. Furthermore, terms “comprising”, “including” or any other variants are intended to cover the non-exclusive including, thereby making that the process, method, object or apparatus comprising a series of elements comprise not only those elements but also other elements that are not listed explicitly or the inherent elements to the process, method, merchandise or apparatus. Without more restrictions, the elements defined by the sentence “including a . . . ” do not exclude the existence of other identical elements in the process, method, article, or device including the elements.

Finally, it should be noted that the above examples are only used to illustrate the technical solutions of the present disclosure, but not to limit them; although the present disclosure has been described in detail with reference to the foregoing examples, those ordinarily skilled in the art should understand that: the technical solutions described in the foregoing examples can still be modified, or some technical features thereof can be equivalently replaced; and these modifications or replacements do not make the essence of the corresponding technical solutions deviate from the spirit and scope of the technical solutions of the examples of the present disclosure. Anything not described in detail in the present disclosure is a technology well known to those skilled in the art.

What is claimed is:

1. A method for increasing an amount of air-quenched steel slag aggregate in concrete, comprising the following steps:
(1) weighing calcium lignosulfonate and silicon-containing powder, mixing same evenly to obtain a modifier, adding water to the modifier, and stirring same to dissolve, to obtain a modified slurry;
(2) weighing air-quenched steel slag, pouring the modified slurry into the air-quenched steel slag, stirring same evenly, and placing same for drying to obtain modified air-quenched steel slag; and
(3) mixing the modified air-quenched steel slag with stones, gravel, yellow sand and cement, adding water thereto, and stirring evenly to obtain a mixture, molding the mixture to obtain a green body, and curing the green body.

2. The method for increasing an amount of air-quenched steel slag aggregate in concrete according to claim 1, wherein in the step (1), a mass ratio of the calcium lignosulfonate to the silicon-containing powder is (1.5-2.5):(1-3).

3. The method for increasing an amount of air-quenched steel slag aggregate in concrete according to claim 1, wherein the silicon-containing powder is selected from at least one of fly ash or silica fume.

4. The method for increasing an amount of air-quenched steel slag aggregate in concrete according to claim 3, wherein the silicon-containing powder is a mixture of the silica fume and the fly ash.

5. The method for increasing an amount of air-quenched steel slag aggregate in concrete according to claim 4, wherein a mass ratio of the calcium lignosulfonate to the silica fume and to the fly ash is 2:1:1.

6. The method for increasing an amount of air-quenched steel slag aggregate in concrete according to claim 1, wherein a particle size of the air-quenched steel slag is 0.1-2.5 mm.

7. The method for increasing an amount of air-quenched steel slag aggregate in concrete according to claim 1, wherein the modifier accounts for 1-2% of a mass of the air-quenched steel slag.

8. The method for increasing an amount of air-quenched steel slag aggregate in concrete according to claim 1, wherein a mass ratio of the stones to the gravel, to the modified air-quenched steel slag, to the yellow sand and to the cement is 6:(0-25):(0-25):12:7.

9. The method for increasing an amount of air-quenched steel slag aggregate in concrete according to claim 1, wherein in the step (3), a water-cement ratio is 0.35-0.45.

10. The method for increasing an amount of air-quenched steel slag aggregate in concrete according to claim 1, wherein in the step (3), a molding pressure is 20-25 MPa, and curing parameters include: static curing time of 3-6 h, a steam curing temperature of 50-80° C., and steam curing time of 6-10 h.
